(19) United States
(12) Patent Application Publication
(10) Pub. No.: US 2014/0217233 A1
(43) Pub. Date: Aug. 7, 2014

(54) AIRCRAFT PROPULSION ASSEMBLY

(71) Applicant: AIRCELLE, Gonfreville L'Orcher (FR)

(72) Inventor: Nicolas DEZEUSTRE, Le Havre (FR)

(73) Assignee: AIRCELLE, Gonfreville L'Orcher (FR)

(21) Appl. No.: 14/245,798

(22) Filed: Apr. 4, 2014

Related U.S. Application Data
(63) Continuation of application No. PCT/FR2012/052260, filed on Oct. 5, 2012.

(30) Foreign Application Priority Data
Oct. 6, 2011 (FR) 1159009

(51) Int. Cl. B64D 27/10

(52) U.S. Cl. CPC B64D 27/10
USPC 244/54

(57) ABSTRACT

An aircraft propulsion assembly includes a support providing a transfer of a force torque to an aircraft from a suspension assembly which is interposed between the support and a turbojet engine. The suspension assembly is mounted on an intermediate housing, a main housing or a fan housing, and on the support. In particular, the suspension assembly includes following suspension fasteners: —a first suspension fastener having a device for absorbing thrust forces and forces “Fz” along an axis “Z”, —a second suspension fastener to absorb, with the first suspension fastener, a moment “Mx” around an axis “X” and forces “Fy” along an axis “Y”, —a third suspension fastener to absorb, with the first suspension fastener, a moment “My” along the axis “Y” and forces “Fx” along an axis “X”. A moment “Mz” along the axis “Z” is absorbed by one of the suspension fasteners.

### CROSS-REFERENCE TO RELATED APPLICATIONS

This application is a continuation of International Application No. PCT/FR2012/052260, filed on Oct. 5, 2012, which claims the benefit of FR 11/59009, filed on Oct. 6, 2011. The disclosures of the above applications are incorporated herein by reference.

### FIELD

The present disclosure generally relates to an aircraft propulsion assembly.

### BACKGROUND

The statements in this section merely provide background information related to the present disclosure and may not constitute prior art.

An aircraft propulsion assembly is formed by a nacelle and a turbojet engine, the assembly being intended to be suspended to a stationary structure of the aircraft, for example a wing or the fuselage, by means of a pylon fastened to the turbojet engine and/or to the nacelle.

The turbojet engine ordinarily comprises a so-called upstream section comprising a fan fitted with blades and a so-called downstream section housing a gas generator.

The fan blades are surrounded by a fan housing enabling to mount the turbojet engine onto the nacelle.

Furthermore, in order to provide force transmission at the interface between the turbojet engine and the stationary structure of the aircraft, the pylon comprises, for example, a rigid box-type structure, formed by assembling spars and lateral panels.

A suspension assembly is provided between the turbojet engine and the pylon, this assembly comprising a plurality of suspension fasteners forming a system for absorbing the forces distributed along the pylon.

More particularly, such a suspension assembly comprises several upstream suspension fasteners secured to the fan housing and/or the intermediate housing and downstream suspension fasteners which are secured to a main housing of the turbojet engine.

This suspension assembly further comprises a device for absorbing the thrust forces generated by the turbojet engine which may generally comprise rods for absorbing thrust forces.

A recurrent issue associated with this type of suspension assembly resides in the torque exerted along a transversal direction of the aircraft, resulting from the shift between the thrust absorbing point of the rods on the fan housing and the main longitudinal axis of the turbojet engine.

A distortion of the turbojet engine occurs due to this torque and the standard suspension assembly provided for bearing the turbojet engine thrust forces.

Such a distortion of the turbojet engine leads to friction between the fan housing and the rotating components of the propulsion assembly such as the blades or vanes of the fan and/or between the vanes of the turbojet engine and the main housing of the latter.

This friction damages the rotating components, limiting the service life of the turbojet engine and reducing the performance of the latter.

Such a distortion may also lead to clearances between the rotating components of the propulsion assembly and the fan housing and/or main housing of the turbojet engine, which also reduce the turbojet engine performance.

Various suspension assemblies have been designed to limit this recurrent issue of turbojet engine distortion. However, they are not entirely satisfactory.

A suspension assembly is particularly known, comprising several upstream hyperstatic suspension fasteners, each designed in such a manner as to absorb forces being exerted along the three directions and the three moments and a downstream suspension fastener mounted between the pylon and an outer housing or ejection housing of the turbojet engine designed in such a manner as to absorb forces being exerted along the vertical direction of the turbojet engine. In such an assembly, the device for absorbing thrust forces is removed.

Such a suspension assembly renders tricky the redundancy of the force pathways and thus requires a complex inspection policy.

Such a suspension assembly further implies use of suspension fasteners having large dimensions and fitted with numerous stiffeners to overcome the removal of the device for absorbing thrust forces and this adversely affects the mass of the aircraft propulsion assembly.

This excess mass of the propulsion assembly and the encumbrance associated with the turbojet engine suspension fasteners are detrimental to the turbojet engine performance and deteriorate it.

### SUMMARY

The present disclosure provides an aircraft propulsion assembly which effectively reduces turbojet engine distortion while providing a mass gain as compared to the existing suspension assemblies, thus improving the propulsion assembly turbojet engine performance.

To this end, the present disclosure provides an aircraft propulsion assembly comprising a turbojet engine, a support providing the transfer of force torque to the aircraft from a suspension assembly as well as said suspension assembly interposed between said support and the turbojet engine, the suspension assembly being mounted, upstream, on an intermediate housing, the upstream of a main housing or a fan housing and, downstream, on said support characterized in that the suspension assembly comprises the following suspension fasteners:
a first suspension fastener comprising at least one device for absorbing thrust forces and configured in such a manner as to absorb forces along the axis leading from a longitudinal axis of the turbojet engine to a longitudinal axis of the support,
at least one second suspension fastener configured in such a manner as to absorb, associated with the first suspension fastener, a moment along a longitudinal axis of the turbojet engine as well as the forces along the axis perpendicular to the longitudinal axis of the turbojet engine and to the axis leading from the longitudinal axis of the turbojet engine to the longitudinal axis of the support,
at least one third suspension fastener configured in such a manner as to absorb, associated with the first suspension fastener, a moment along an axis perpendicular to the longitudinal axis of the turbojet engine and to the axis leading from the longitudinal axis of the turbojet engine to the longitudinal axis of the support as well as the forces along the longitudinal axis of the turbojet engine,

a moment along the axis leading from the longitudinal axis of the turbojet engine to the longitudinal axis of the support being absorbed either by the first suspension fastener, or by the second suspension fastener or by the third suspension fastener, depending on the respective configuration thereof.

According to other features of the thrust reverser according to the present disclosure, taken alone or in combination:
the suspension assembly is isostatic;
one or more second suspension fasteners and the first suspension fastener are configured to absorb forces along the axis perpendicular to the longitudinal axis of the turbojet engine and to the axis leading from the longitudinal axis of the turbojet engine to the longitudinal axis of the support, these forces being offset along the direction leading from the longitudinal axis of the turbojet engine to the longitudinal axis of the support, to absorb the moment around the longitudinal axis of the turbojet engine;
one or more third suspension fasteners and the first suspension fastener are configured to absorb forces along the longitudinal axis of the turbojet engine, these forces being offset along the direction leading from the longitudinal axis of the turbojet engine to the longitudinal axis of the support, to absorb the moment around the axis perpendicular to the longitudinal axis of the turbojet engine and to the axis leading from the longitudinal axis of the turbojet engine to the longitudinal axis of the support;
the third suspension fastener is mounted at the longitudinal axis of the support of the turbojet engine;
the first suspension fastener is configured to absorb forces along the longitudinal direction, these forces being offset along the direction perpendicular to the longitudinal axis of the turbojet engine and to the axis leading from the longitudinal axis of the turbojet engine to the longitudinal axis of the support, to absorb the moment around the axis leading from the longitudinal axis of the turbojet engine to the longitudinal axis of the support;
the second and/or third suspension fasteners are doubled;
the third suspension fasteners are configured to absorb the moment around the axis leading from the longitudinal axis of the turbojet engine to the longitudinal axis of the support;
the third suspension fasteners are configured to absorb forces along the longitudinal axis of the turbojet engine between a force absorbing point of the thrust absorbing device and the periphery of the intermediate housing or the fan housing, these longitudinal forces being offset along the axis perpendicular to the longitudinal axis of the turbojet engine and to the axis leading from the axis of the turbojet engine to that of the support;
the third suspension fasteners are mounted between the support and an outer ferrule of the intermediate housing or the fan housing symmetrically with respect to the median plane defined by the longitudinal axis and the axis leading from the longitudinal axis of the turbojet engine to the longitudinal axis of the support;
the third suspension fasteners comprise at least one latching rod, connected, at an upstream end, by means of a yoke, to a fixing support secured to the support and, at a downstream end, to the intermediate housing or to the fan housing via a latching support;
the second suspension fasteners may be configured to absorb the moment around the axis leading from the longitudinal axis of the turbojet engine to longitudinal axis of the support;
the suspension fasteners comprise standby force pathways, in case of rupture of the main force pathway;
the suspension fasteners comprise doubled force pathways, in case of rupture of one of these force pathways.

The present disclosure also relates to an aircraft comprising at least one propulsion assembly such as the one that has just been introduced.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a sectional view of an aircraft propulsion assembly comprising a suspension assembly according to a first form of the present disclosure;

FIG. 2 is a perspective view of the aircraft propulsion assembly of FIG. 1;

FIG. 3 is a partial perspective view of suspension fasteners interposed between a ferrule of an intermediate housing of the turbojet engine and a pylon of the assembly of FIG. 1, viewed from a downstream of the propulsion assembly;

FIG. 4 is a view, in a longitudinal/transverse plane, of the suspension fasteners interposed between a ferrule of an intermediate housing of the turbojet engine and a pylon of FIG. 3;

FIG. 5 is an axial view, viewed from the upstream of the propulsion assembly, of the suspension fasteners interposed between a ferrule of an intermediate housing of the turbojet engine and a pylon of the assembly of FIG. 1;

FIGS. 6a and 6b are respectively cross-section and perspective views of an aircraft propulsion assembly comprising a suspension assembly according to a second form of the present disclosure;

FIGS. 7a and 7b are perspective views, respectively, viewed from the upstream and downstream of the propulsion assembly, of an aircraft propulsion assembly comprising a suspension assembly according to a third form of the present disclosure;

FIG. 8 shows a schematic cross-section of a propulsion assembly, on which the suspension assemblies of FIGS. 3 to 7b can be fastened; and

FIG. 9 illustrates the axis system used in the described aircraft propulsion assemblies.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

With reference to FIG. 9, it should be noted that care was taken to define in the description a coordinate system having three axes X, Y, Z, these three axes representing:
the longitudinal direction of the turbojet engine for axis X,
the direction leading from the longitudinal axis of the turbojet engine to the longitudinal axis of the pylon for direction Z and,
the direction orthogonal to X and Z for axis Y.

In the case of a propulsion assembly mounted under the wing, the axis Z is generally vertical.

In the following description, the vertical axis will be assimilated to axis Z, although the propulsion assembly is mounted in another configuration, such as for example in rear fuselage, for the sake of simplification.

It should also be noted that the terms upstream and downstream are meant with respect to the travelling direction of the aircraft encountered following a thrust exerted by the turbojet engine.

Furthermore, the following forces and moments will be considered:
Fx, forces along an axis substantially parallel to the axis X, and a moment Mx substantially around this axis.
Fy, forces along an axis substantially parallel to the axis Y, and a moment My substantially around this axis.
Fz, forces along an axis substantially parallel to the axis Y, and a moment Mz substantially around the axis.

In the following description, the term force generally describes the “force” component of the force torque, composed of three forces and three moments, along each of the three axes X, Y and Z.

Similarly, in the following description, force absorptions in the three main directions and the moment absorptions are substantially in the directions X, Y and Z defined above.

A limited angle with respect to these directions due to design constraints as described hereinafter does not change the overall operation of the suspensions and remains within the scope of this present disclosure.

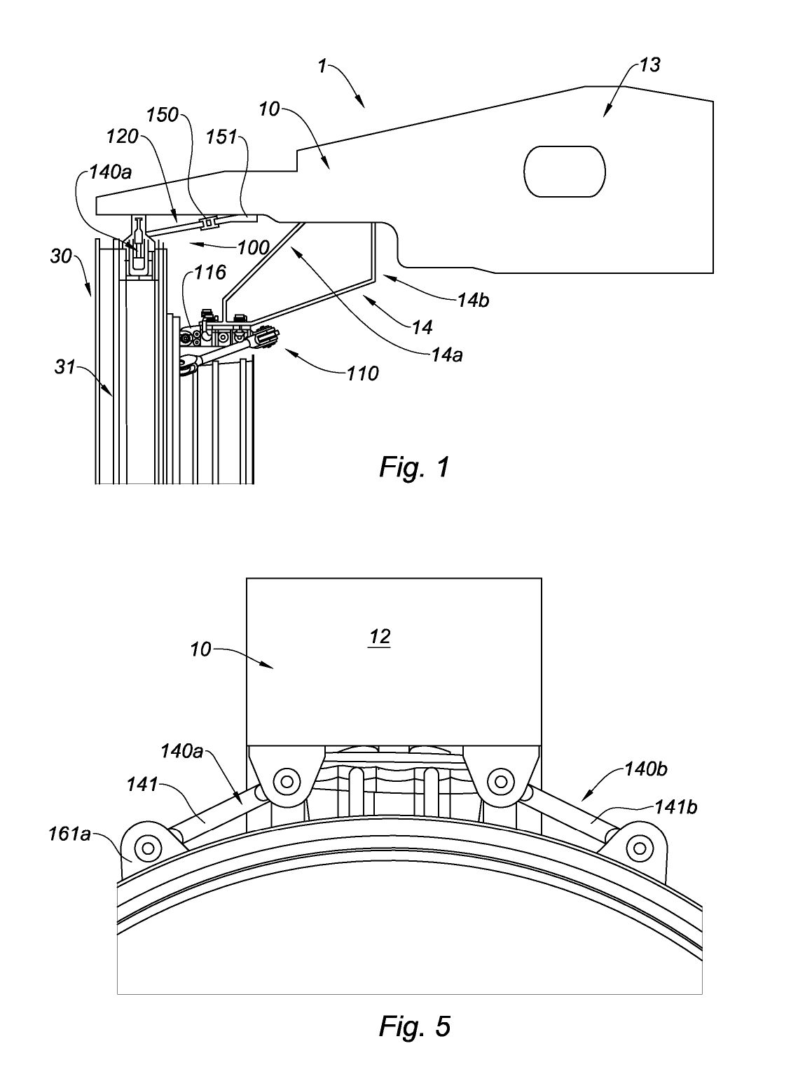

With reference to FIG. 1, a portion of a propulsion assembly 1 for an aircraft according to a first form of the present disclosure can be seen.

Generally, this aircraft propulsion assembly 1 is formed in particular by a nacelle (not shown), a turbojet engine (not shown), a pylon 10 and a suspension assembly 100 providing the fixing of the turbojet engine under this pylon 10.

This aircraft propulsion assembly 1 is intended to be suspended to a stationary structure of the aircraft (not shown), for example under a wing or on the fuselage, by means of the pylon 10.

Regarding the pylon 10, it takes the form of a longitudinal rigid structure and, more particularly, a structure comprising a rigid box 12 capable of transmitting the forces between the turbojet engine and the structure of the aircraft.

This box 12 extends in a vertical plane passing through the longitudinal axis parallel to direction X.

It is formed of upper and lower spars 13, connected together by lateral panels.

The pylon 10 further comprises, projecting from the box 12, a rigid structure 14 adapted to be connected to a suspension fastener system 110 designated as a first suspension fastener in the description hereinafter.

Such a structure 14 comprises several branches 14a, 14b having a right-angled curvature, adapted to be fixed on the first suspension fastener 110.

More particularly, it comprises a first pair of branches 14a, offset along direction Y, each comprising a first portion fixed to the first suspension fastener 110, which extends along direction Z and is extended by a second portion extending in a plane XZ up to the box 12.

A second pair of branches 14b, offset along direction Y, is also provided, each of the branches comprising a first portion fixed onto the box 12 which extends along direction Z and is extended by a second portion extending in a plane XZ upstream towards the first suspension fastener 110.

This structure 14 is adapted to provide the transmission of forces from the first suspension fastener 110 to the pylon 10. It is provided by way of non-limiting example and other designs not shown may be considered without departing from the scope of the present disclosure.

In particular, the suspension fastener 110 may be connected directly to the pylon 10.

More generally, the pylon 10 may be replaced with any equivalent element adapted to provide the transfer of the force torque to the aircraft from a suspension assembly.

Thus, each suspension fastener may be connected either directly or through intermediate structures to the pylon 10 or to the equivalent thereof making it possible to transfer the force torque from the suspension fasteners to the rest of the airplane without departing from the scope of this present disclosure.

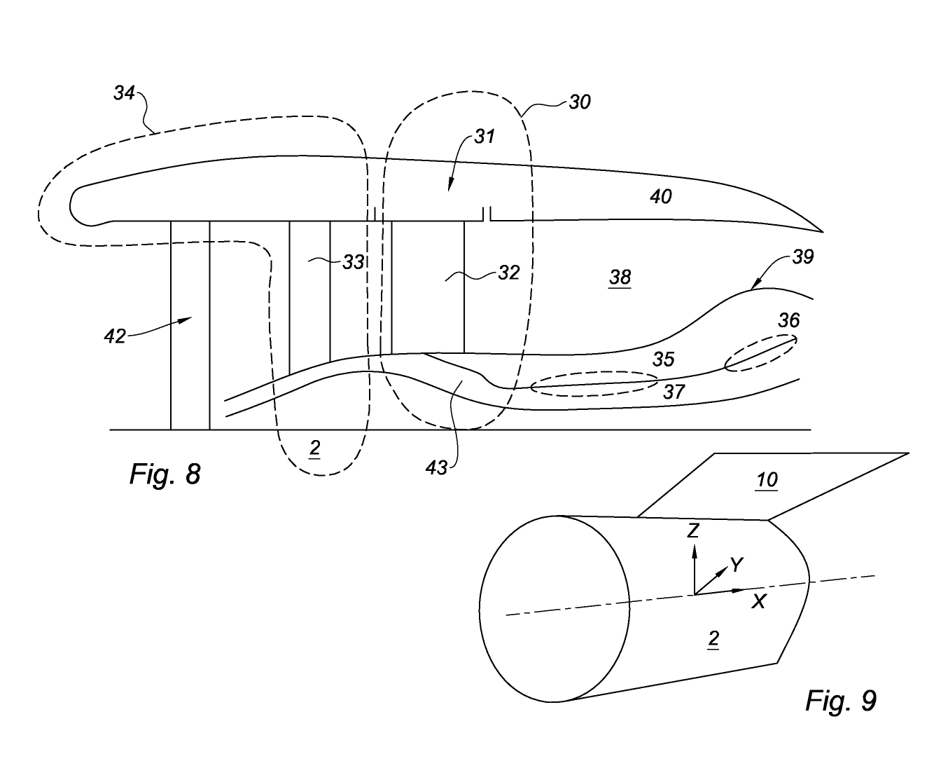

FIG. 8 depicts the environment of a turbojet engine 2 by way of a non-limiting example for the present disclosure.

The turbojet engine 2 comprises a fan 42 delivering an annular flow with a primary flow 37 which supplies the turbojet engine 2 driving the fan 42 and a secondary flow 38 which is ejected into the atmosphere while providing a significant fraction of the aircraft thrust.

The fan 42 is contained in a fan housing 34 which channels the secondary flow 38 downstream.

This housing 34 defines a portion of the nacelle inner wall and has substantially the shape of an annular ferrule.

This fan housing 34 is adapted to surround the turbojet engine fan 42 mainly composed of a rotating shaft.

It may carry a plurality of flow straightening blades 33 allowing to straighten the secondary air flow 38 generated by the fan 42.

This fan is rotatably mounted on a stationary hub 43 which can be connected to the fan housing 34 by a plurality of stationary arms 32 located upstream or downstream of the blades 33 or directly by these blades 33.

In this second configuration, the straightening blades 33 act as force transmission elements in addition to or instead of the connecting arms 32.

The straightening blades 33 may thus be placed in the intermediate housing 30 instead of the fan housing 34.

The fan housing 34 is connected at its downstream end to an intermediate housing 30 belonging to the median section of the nacelle.

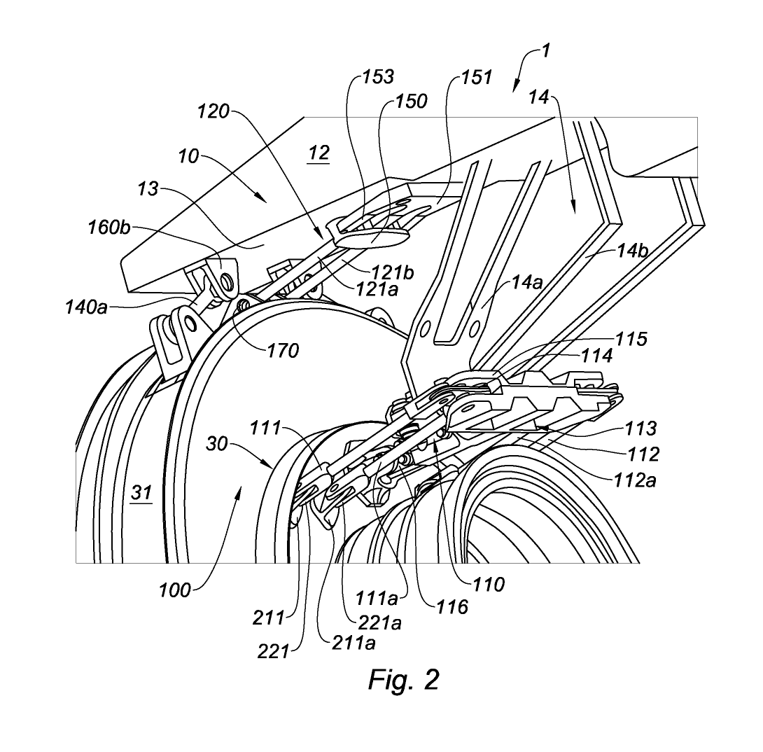

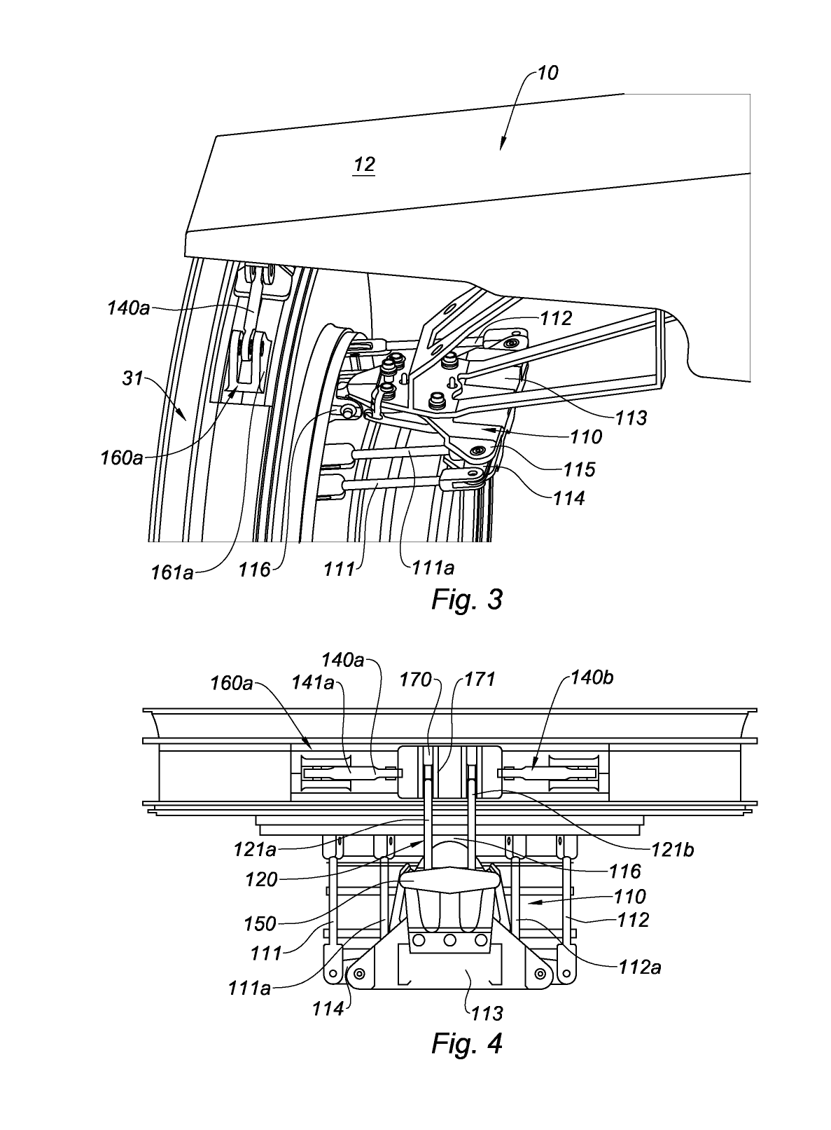

The secondary air flow 38 generated by the fan also crosses the wheel formed by the intermediate housing 30, shown schematically in gray in FIGS. 2 and 3.

The intermediate housing 30 is a structural member which comprises the hub 43, an outer annular ferrule 31 and possibly the radial connecting arms 32 and the flow straighteners 33 which connect the hub to the outer ferrule 31. This housing 30 may be made of several portions or not.

Downstream of this intermediate housing 30, the secondary flow 38 stream is internally delimited by the outer wall 40 and inner wall 39 of the potential reverser.

The inner wall 39 surrounds a cylindrical envelope called main housing 35 which itself surrounds the body of the turbojet engine 2 and which extends from the hub of the intermediate housing 30 to an exhaust housing 36 located at the outlet of the turbine.

This main housing 35 has radial dimensions smaller than the outer ferrule 31 of the intermediate housing 30.

The different housings may be secured together.

Regarding the suspension assembly 100, it makes it possible to transmit to the aircraft the mechanical forces of the turbojet engine 2 and the forces originating from the nacelle transmitted by the turbojet engine 2 during the different operating conditions thereof.

The loads to be taken into consideration are oriented along the three main directions (forces and moments).

These are, in particular, the inertial loads of the turbojet engine 2, the thrust of the latter, the aerodynamic loads or even the torque absorption around axis X of the turbojet engine 2.

In a first form illustrated in FIGS. 1 to 5, the suspension assembly 100 comprises, more specifically, the following suspension fasteners, mounted between the outer ferrule 31 of the intermediate housing 30 or the fan housing 34 or at the front of the main housing 35 and the pylon 10:
at least one suspension fastener 140 configured in such a manner as to absorb, associated with the first suspension fastener 110, a moment Mx along the longitudinal axis of the turbojet engine and forces Fy along the transverse axis of the turbojet engine.

More particularly, several suspension fasteners 140 and the first suspension fastener 110 are configured to absorb two axial forces Fy along the transverse axis, these forces being offset along the vertical axis Z. These suspension fasteners 140 will be described hereinafter in connection with FIGS. 1 to 5.
at least one suspension fastener 120 configured in such a manner as to absorb, associated with the first suspension fastener 110, a moment My along the transverse axis of the turbojet engine and forces Fx along axis X of the turbojet engine.

More particularly, the upstream suspension fastener 120 and the first suspension fastener 110 are configured to absorb the moment My through forces Fx along the longitudinal axis, offset along the vertical axis Z of the turbojet engine 2. These suspension fasteners 120 will be described hereinafter in connection with FIGS. 1 to 5.
the first suspension fastener 110 comprising at least one device for absorbing the thrust forces 111, 112, said fastener 110 being configured in such a manner as to absorb a moment Mz along the vertical axis of the turbojet engine.

To absorb the moment Mz around the vertical axis, the first suspension fastener 110 is configured to absorb forces Fx along axis X, these forces Fx being offset along the transverse axis Y.

The first suspension fastener 110 also absorbs the forces Fz and Fy along the axes Z and Y, at a fastening member 116.

As indicated above, the first suspension fastener 110 is also associated with the suspension fasteners 140 to absorb the moment Mx and transverse forces Fy and associated with the suspension fastener 120 to absorb the moment My along the transverse axis of the turbojet engine and forces Fx along the axis of the turbojet engine.

The first suspension fastener 110 is now described in connection with FIGS. 1 to 4.

In this alternative form, the first suspension fastener 110 is configured in such a manner as to absorb the moment Mz along the vertical axis and the force Fz along the vertical axis. In addition, it is also configured to participate with the suspension fasteners 120 and 140 in absorbing the moments Mx and My and the forces Fy and Fx.

More specifically, the device for absorbing the thrust forces of the suspension fastener 110 comprises two lateral rods 111, 112 for absorbing the thrust forces, extending in a plane XZ.

These two lateral rods 111, 112 are mounted symmetrically on either side of the median plane XZ.

These rods are mounted, at the upstream end thereof, via anchoring points on the central portion of the intermediate housing 30 and, at the downstream end thereof, they are mounted on a yoke 114.

The lateral rods 111, 112 are each connected to the intermediate housing 30 by means of a corresponding support 211.

Each support 211 comprises a clevis 221 intended to cooperate with two clevises of the corresponding latching rod 111, 112.

The three clevises are connected together, for example, by an adapted ball joint.

It should be noted that it is also possible to arrange a clevis on each latching rod 111, 112 and two clevises on each corresponding support 211.

These two lateral rods 111, 112 are each articulated, at the downstream end thereof, on the yoke 114, for example through ball joints.

It should be noted that it is also possible to have two clevises on each rod 111, 112 and a clevis on the corresponding yoke 114.

The yoke 114 is connected to a beam 113 by means, for example, of an axis perpendicular to the plane of the yoke 114, at the center thereof, or by any other suitable means.

This axis is then secured to two clevises 115 of the beam 113.

It should be noted that it is also possible to have two clevises on the yoke 114 and a clevis on the beam 113.

Regarding the beam 113, it extends substantially in a plane XY and has a generally T-shaped section.

The beam 113 absorbs the forces along the axes Fy and Fz, at the latching member 116.

This latching member 116 is, for example, a longitudinal direction axis surrounded by a ball fitting into the intermediate housing 30.

Moreover, the beam 113 is connected to the pylon 10, for example, by means of the rigid structure 14 formed of two pairs of rigid branches 14a, 14b described above in connection with FIG. 1. This connection may be provided by bolts and possibly by shear pins.

To provide redundancy, a system for doubling the force pathways may be provided.

Such a system may comprise, as illustrated in FIGS. 1 to 4, a doubling of each of the rods 111, 112 for absorbing thrust forces, with an identical rod respectively 111a and 112a parallel and offset along Y.

The fixing of the rods 111a, 112a to the beam 113 via the yoke 114 is identical to that of the rods 111 and 112 described above (the support 221 and the associated clevis 22a to mount the rod 111a are illustrated in particular in FIG. 2).

The yokes 114 are then provided for example in two superimposed portions, the axis or central pin being doubled by comprising a solid pin and a surrounding hollow pin.

These yokes 114 comprise, in addition, abutments for limiting rotation.

The beam 113 may also be formed of two portions joined by fixing means, this junction being for example in a plane XZ in the upstream portion of the beam and in a plane XY in the downstream portion of the beam.

With reference to FIGS. 1 to 5 more particularly, a suspension fastener 120 and two suspension fasteners 140 are mounted on the outer periphery of the outer ferrule 31 of the intermediate housing 30, at the downstream end of this ferrule 31 or the fan housing 34. The three suspension fasteners 120, 140 are thus grouped on the upper portion of the outer periphery of the outer ferrule 31 of the intermediate housing 30 or the fan housing 34.

With reference to FIGS. 1, 2 and 4, regarding the suspension fastener 120, this suspension fastener 120 is mounted on the periphery of the outer ferrule 31 of the intermediate housing 30 or of the fan housing 34 in the axis of the nacelle support 10, namely at the highest point of the outer ferrule 31 of the intermediate housing 30 or the fan housing 34.

It extends in a plane XZ, connected, at an upstream end, to the upstream of the box 12 of the pylon 10, and at a downstream end, to the outer periphery of the outer ferrule 31 of the intermediate housing 30 or the fan housing 34.

The suspension fasteners 120 may also be directed towards the upstream of the pylon 10 or towards the downstream of the pylon 10 for all the described forms.

The redundancy aspect of the transmission of forces from the suspension fastener 120 is achieved for example by two rods 121a and 121b associated with a yoke 150, which can itself be provided with a system for limiting rotation in case of rupture of a rod.

This yoke 150 may be designed to accept ruptures without losing its function.

Other principles for obtaining the redundancy of the force pathway are possible without departing from the scope of this present disclosure such as, for example, a rod mounted without clearance and a rod mounted with clearance so that this rod with clearance would not be active unless the force pathway of the other rod has ruptured.

This suspension fastener 120 comprises two rods 121a and 121b.

These parallel latching rods 121a, 121b extend in a plane XZ, connected, at a downstream end, by means of a yoke 150, to a fixing support secured to the lower spar 13 of the box 12 of the pylon 10 and, at an upstream end, to the outer ferrule 31 of the intermediate housing 30 or the fan housing 34 via a latching support 170 or inversely.

The latching rod(s) 121a, 121b is/are articulated, at the downstream end thereof, on the yoke 150 by a ball joint connection.

The yoke 150 is, in turn, mounted on the upstream end of the lower spar 13 of the box 12 by means of fixing support 151. It is pivotally mounted with respect to this support 151 along the central axis thereof, substantially along direction Z.

As indicated above, the yoke 150 is provided with a system for limiting rotation around the central axis thereof, for example, by axes or pins mounted with clearance between the yoke and outer legs of the support 151.

Furthermore, the fixing support 151 is integrally fixed to the upstream end of the lower spar 13 of the box 12 of the pylon 10 by means of several connections along direction Z, which in one form are shear pins.

As illustrated in FIGS. 2 and 4 in particular, the latching supports 170 are mounted on the periphery of the outer ferrule 31 via suitable fixing means. They may in particular be formed integrally with the outer ferrule 31 of the intermediate housing 30 or the fan housing 34.

The latching supports 170 may be doubled or not so as to have a support per latching rod 121a, 121b.

Each support 170 comprises two parallel clevises 171, offset along Y, adapted to cooperate with a clevis arranged on the downstream end of the rod 121a, 121b of the corresponding suspension fastener 120.

The three clevises are connected together, for example, by an adapted ball joint.

It should be noted that it is also possible to have two clevises on each latching rod 121a, 121b and a clevis on the corresponding latching support.

With reference to FIGS. 2, 4 and 5 more particularly, two suspension fasteners 140a, 140b are symmetrical relative to the median plane XZ and offset along Y.

These two suspension fasteners 140a, 140b extend in a plane YZ, connected, at one end, to the upstream of the box 12 of the pylon 10 and, at an opposite end, to the outer periphery of the outer ferrule 31 of the intermediate housing 30 or the fan housing 34.

One of these two suspension fasteners 140a, 140b is a standby pathway, mounted for example with clearance, in case the other suspension fastener 140, 140b is broken.

Any other redundant system, such as for example a double rod, fails within the scope of this present disclosure, the two rods 140a, 140b being a form of the redundancy function related to the principle of the suspension fasteners 140.

One single suspension fastener 140a will be described in connection with these figures.

It comprises a latching rod 141a extending in a plane YZ and fixed at an end respectively to a latching support 160a secured to the outer ferrule 31 of the intermediate housing 30 or the fan housing 34 and, at the opposite end, to a latching support 160b secured to the lower spar 13 of the pylon 10.

Each support 160a comprises two clevises 161a intended to cooperate with a clevis arranged at the end of the rod 141a of the corresponding suspension fastener 140a.

The three clevises are connected together, for example, by an adapted ball joint.

It should be noted that it is also possible to have two clevises on each rod 141a and a clevis on each support 160a, 160b.

Additional suspension fasteners may be considered without departing from the scope of the present disclosure.

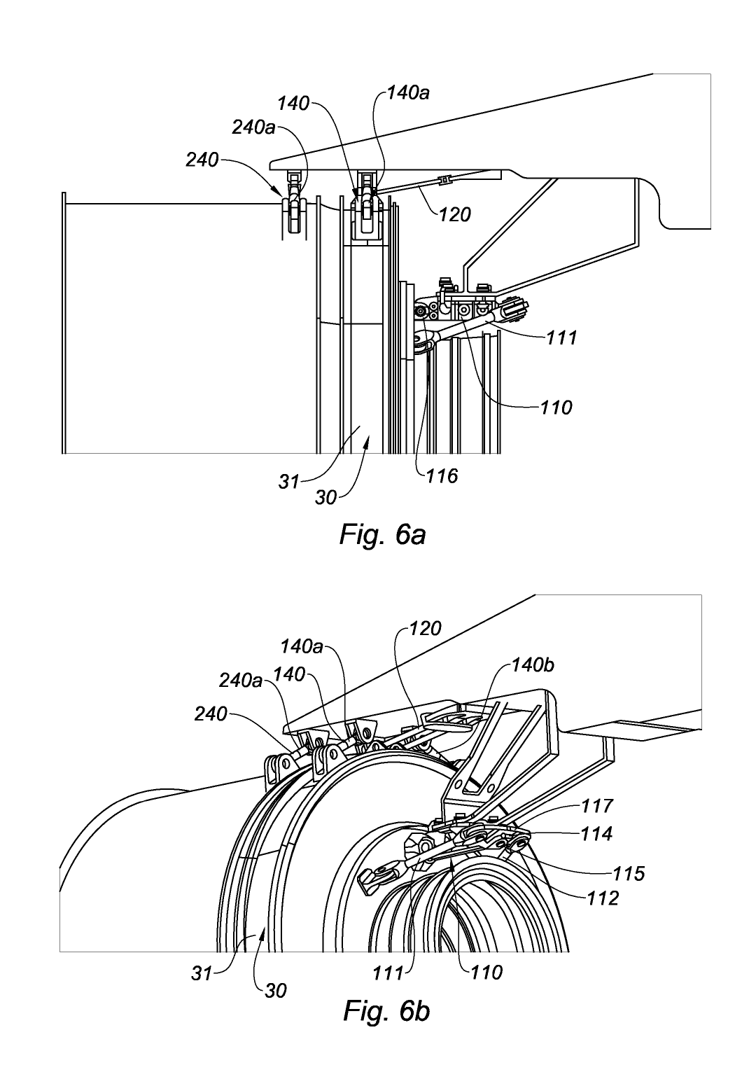

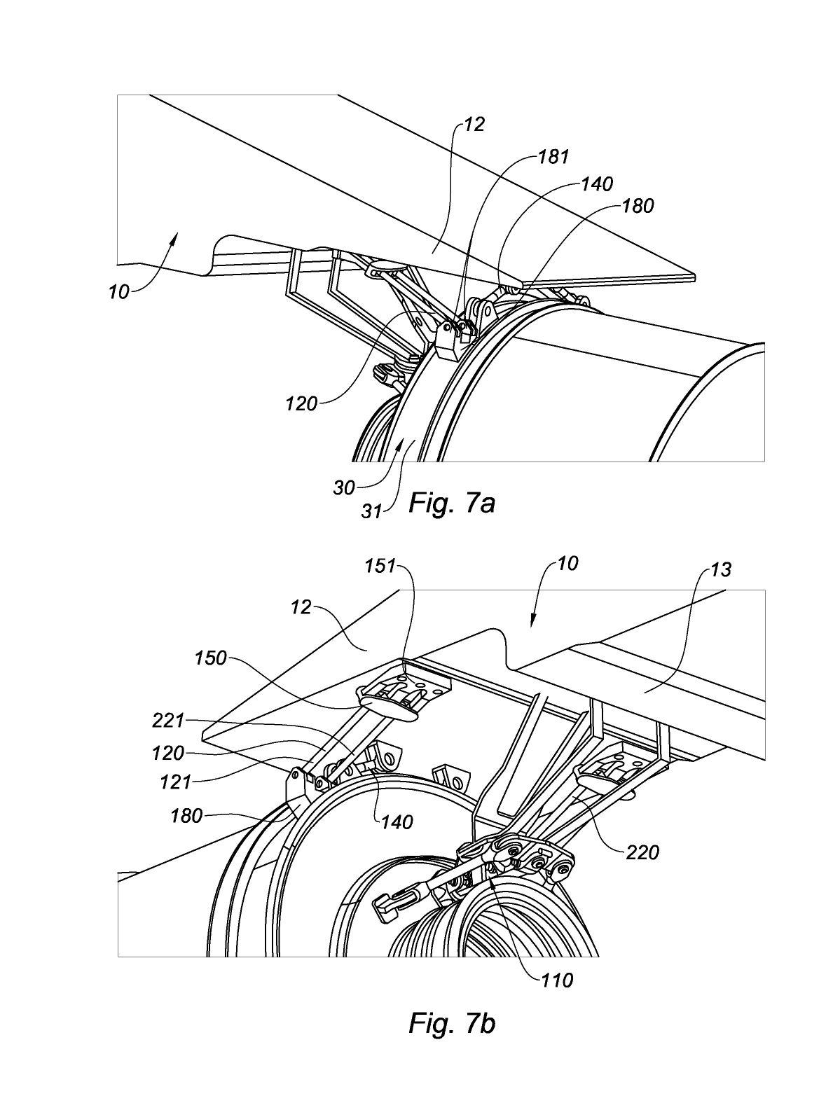

Two other forms will thus be described in connection, respectively, with FIGS. 6a, 6b and 7a, 7b.

In these two forms, it is envisaged to double either the suspension fasteners 120 or the suspension fasteners 140 described in connection with FIGS. 1 to 5.

With reference to FIGS. 6a and 6b, a second form provides for the following suspension assembly 100:
the pair of suspension fasteners 140 is doubled and the assembly is configured in such a manner as to absorb the moment Mz along the vertical axis of the turbojet engine and, associated with the first suspension fastener 110, it also absorbs the moment Mx along the longitudinal axis of the turbojet engine, as well as transverse forces Fy;
the second suspension fastener 120 absorbing the moment My along the transverse axis in association with the first suspension fastener 110 is identical to that described in connection with FIGS. 1 to 5;
the first suspension fastener 110 is configured to absorb the forces Fz along the vertical direction and, associated with a pair of suspension fasteners 140, the moment Mx and the forces Fy and, associated with the second suspension fastener 120, the moment My, as well as forces Fx.

As illustrated in FIGS. 6a and 6b, two pairs of suspension fasteners 140 and 240 are mounted on the ferrule 31 of the intermediate housing 30 or the fan housing 34.

The two pairs of suspension fasteners 140 and 240 are offset along X and symmetrical in a plane XY.

Each pair of suspension fasteners 140/240 comprises an operative suspension fastener and a standby suspension fastener, in case of rupture of the operative suspension fastener. Redundancy of force pathways may be provided by means other than the one described above.

The description of the suspension fasteners 140a and 140b in connection with FIGS. 1 to 5 applies to both respective pairs 140a, 140b and 240a, 240b (not shown) of this second form.

Regarding the first suspension fastener 110, the latter was simplified.

It is no longer configured to absorb the moment Mz.

More specifically, the device for absorbing thrust is identical to the one described in connection with FIGS. 1 to 5.

The two lateral rods 111, 112 for absorbing thrust force extending in a plane XZ are mounted, at the downstream end thereof, by means of a yoke 117 and the beam 113 to the pylon 10 through the rigid structure 14.

To provide the system redundancy, a system for doubling the force pathways may be provided.

With reference to FIGS. 7a and 7b, a third form provides for the following suspension assembly 100:
the pair of suspension fasteners 140 absorbing the moment Mx along the transverse axis in association with the first suspension fastener 110 is identical to the one described in connection with FIGS. 1 to 5.
the second suspension fastener 120 is doubled and the assembly is configured in such a manner as to absorb the moment Mz along the vertical axis of the turbojet engine and, associated with the suspension fastener 110, it also absorbs the moment My, as well as the forces Fx;
the first suspension fastener 110 is configured to absorb the forces Fz along the vertical direction and, associated with a pair of suspension fasteners 140, the moment Mx and forces Fy and, associated with the second fastener suspension 120, the moment My, as well as the forces Fx.

The suspension fasteners 120 thus doubled are configured to absorb two forces along the longitudinal axis between a point of the box 12 of the pylon 10 and the periphery of the intermediate housing 30 or the fan housing 34, these two longitudinal forces being offset along the transverse axis Y of the turbojet engine.

Furthermore, in this form, the first suspension fastener 110 is identical to the one described in connection with FIGS. 6a and 6b.

Regarding the suspension fasteners 120, 220, a form is illustrated in FIGS. 7a and 7b.

Four identical suspension fasteners forming a pair of suspension fasteners 120 and a pair of suspension fasteners 220 are mounted on the outer periphery of the outer ferrule 31 of the intermediate housing 30 or the fan housing 34.

These suspension fasteners 120, 220 are symmetrically mounted in pairs with respect to the median plane XZ.

Each fastener pair is thus offset along direction Y, starting from the peripheral lateral end thereof, typically of the width of the box 12 of the pylon 10.

The four suspension fasteners 120, 220 are thus grouped on the upper portion of the outer periphery of the outer ferrule 31 of the intermediate housing 30 or the fan housing 34.

The description of the suspension fastener 120 in connection with FIGS. 1 to 5 applies to both pairs of respective suspension fasteners 120 and 220 of this third form.

The set of rods 120, 220 associated with the latching system thereof is designed to be redundant. The loss of any element of the force pathway does not lead to the total loss of this force pathway. The force pathways redundancy may be provided by means other than the one described above.

Regarding the different suspension fasteners, for all the described forms, they may be achieved according to any form known to the skilled person such as, for example, the one related to the assembling of shackles, yokes and fittings intended to cooperate with a rod or even a shear pin type articulation system.

For all the described forms, these suspension fasteners may also be provided with systems providing the redundancy of the transmission of forces (forces and moments), for example, doubled force pathways, standby force pathway, fail safe axes, that is to say fitted with main connecting axes housed in concentric sleeves providing the transmission of force in case of rupture of the main connecting axis or the sleeve, or any other.

The suspension assembly 100 is generally isostatic.

In such a suspension assembly 100, any suspension fastener secured to the rear portion of the main housing 40 of the turbojet engine and/or the exhaust housing 41 is removed.

With the suspension assembly 100 according to the present disclosure, the set of loads (forces and moments) is absorbed in an upstream plane of the turbojet engine.

Any suspension fastener on the rear portion of the main housing of the turbojet engine or on the exhaust housing is absent, which considerably reduces distortion of the turbojet engine, and in particular bending of the latter during the different operating conditions thereof.

The contacts between the rotating components of the turbojet engine and the corresponding housings are decreased, thereby improving the service life of the turbojet engine.

Moreover, the number of suspension fasteners located in the secondary flow channel being decreased, disturbances due to the presence of these suspension fasteners in this channel are in turn decreased, which improves the performance of the propulsion assembly.

Although the present disclosure has been described with a particular form, it is obvious that it is in no way limited thereto and that it includes all technical equivalents of the described means as well as combinations thereof if the latter fall within the scope of the present disclosure.

What is claimed is:

1. An aircraft propulsion assembly comprising a turbojet engine, a support providing a transfer of a force torque to an aircraft from a suspension assembly, said suspension assembly interposed between said support and the turbojet engine, the suspension assembly being mounted, upstream, on an intermediate housing, an upstream of a main housing or a fan housing and, downstream, on said support, wherein the suspension assembly comprises fasteners including:
a first suspension fastener comprising at least one device for absorbing thrust forces and configured to absorb forces “Fz” along an axis leading from a longitudinal axis of the turbojet engine to a longitudinal axis of the support,
at least one second suspension fastener configured to absorb, associated with the first suspension fastener, a moment “Mx” along the longitudinal axis of the turbojet engine as well as the forces “Fy” along an axis perpendicular to the longitudinal axis of the turbojet engine and to an axis leading from the longitudinal axis of the turbojet engine to the longitudinal axis of the support, and
at least one third suspension fastener configured to absorb, associated with the first suspension fastener, a moment “My” along the axis perpendicular to the longitudinal axis of the turbojet engine and to the axis leading from the longitudinal axis of the turbojet engine to the longitudinal axis of the support as well as forces “Fx” along the longitudinal axis of the turbojet engine,
wherein a moment “Mz” along the axis leading from the longitudinal axis of the turbojet engine to the longitudinal axis of the support is absorbed either by the first suspension fastener, or the second suspension fastener or the third suspension fastener, depending on the respective configuration thereof.

2. The assembly according to claim 1, wherein the suspension assembly is isostatic.

3. The assembly according to claim 1, wherein one or more second suspension fasteners and the first suspension fastener are configured to absorb the forces “Fy” along the axis perpendicular to the longitudinal axis of the turbojet engine and to the axis leading from the longitudinal axis of the turbojet engine to the longitudinal axis of the support, the forces “Fy” being offset along a direction leading from the longitudinal axis of the turbojet engine to the longitudinal axis of the support, to absorb the moment “Mx” around the longitudinal axis of the turbojet engine.

4. The assembly according to claim 1, wherein one or more third suspension fasteners and the first suspension fastener are configured to absorb the forces “Fx” along the longitudinal axis of the turbojet engine, the forces “Fx” being offset along the direction leading from the longitudinal axis of the turbojet engine to the longitudinal axis of the support, to absorb the moment “My” around the axis perpendicular to the longitudinal axis of the turbojet engine and to the axis leading from the longitudinal axis of the turbojet engine to the longitudinal axis of the support.

5. The assembly according to claim 4 wherein the third suspension fastener is mounted at the axis of the support of the turbojet engine.

6. The assembly according to claim 1, wherein the first suspension fastener is configured to absorb the forces “Fx” along the longitudinal direction of the turbojet engine, the forces “Fx” being offset along a direction perpendicular to the longitudinal axis of the turbojet engine and to the axis leading from the longitudinal axis of the turbojet engine to the longitudinal axis of the support, to absorb the moment “Mz” around the axis leading from the longitudinal axis of the turbojet engine to the longitudinal axis of the support.

7. The assembly according to claim 1, wherein at least one of the second and third suspension fasteners are doubled.

8. The assembly according to claim 7, wherein the third suspension fasteners are configured to absorb the moment “Mz” around the axis leading from the longitudinal axis of the turbojet engine to the longitudinal axis of the support.

9. The assembly according to claim 8, wherein the third suspension fasteners are configured to absorb forces along a longitudinal axis between a force absorbing point of said at least one device for absorbing thrust forces and a periphery of the intermediate housing or the fan housing, the two longitudinal forces being offset along the axis perpendicular to the longitudinal axis of the turbojet engine and to the axis leading from the axis of the turbojet engine to that of the support.

10. The assembly according to claim 8, wherein the third suspension fasteners are mounted between the support and an outer ferrule of the intermediate housing or the fan housing symmetrically with respect to a median plane defined by the longitudinal axis and the axis leading from the longitudinal axis of the turbojet engine to the longitudinal axis of the support.

11. The assembly according to claim 1, wherein the third suspension fasteners comprise at least one latching rod, connected at an upstream end, by means of a yoke to a fixing support secured to the support and, at a downstream end, to the intermediate housing or to the fan housing via a latching support.

12. The assembly according to claim 7, wherein the second suspension fasteners can be configured to absorb the moment “Mz” around the axis leading from the longitudinal axis of the turbojet engine to that of the support.

13. The assembly according to claim 1, wherein the suspension fasteners comprise standby force pathways, in case of rupture of a main force pathway.

14. The assembly according to claim 13, wherein the suspension fasteners comprise doubled force pathways, in case of rupture of one of the force pathways.

15. Aircraft comprising at least one propulsion assembly according to claim 1.
